(19) United States
(12) Patent Application Publication
(10) Pub. No.: US 2012/0002831 A1
(43) Pub. Date: Jan. 5, 2012

(54) ELECTRICAL HEARING AID ADAPTER

(75) Inventors: Chee Leong Chan, Singapore (SG); Lilyana Joeng, Singapore (SG); Kah Hoe Royston Lee, Singapore (SG); Cher Huat Lim, Singapore (SG); Meng Kiang Lim, Singapore (SG); Armand Kertoputro Santoso, Singapore (SG)

(73) Assignee: SIEMENS MEDICAL INSTRUMENTS PTE. LTD., SINGAPORE (SG)

(21) Appl. No.: 13/256,273

(22) PCT Filed: Mar. 13, 2009
(86) PCT No.: PCT/SG09/00086

§ 371 Date: Sep. 13, 2011

(51) Int. Cl. H04R 25/00

(52) U.S. Cl. 381/315; 381/323

(57) ABSTRACT

An electrical hearing aid adapter is provided. The electrical hearing aid adapter may be configured to transfer programming data to a hearing aid having a first end portion formed in such a manner that it corresponds to the shape of a battery compartment receiving chamber being configured to receive a hearing aid battery compartment. The electrical hearing adapter may further include an interface configured to receive programming data and to transfer received programming data to an electrical contact portion arranged on the first end portion. The first electrical contact portion may be arranged such that it electrically contacts to a second electrical contact portion placed in the battery compartment receiving chamber, when the first end portion is inserted into the battery compartment receiving chamber.

Embodiments relate generally to an electrical hearing aid adapter.

In consideration of the fact of an increase of average age of the population in almost all of the industrialized and emerging countries, a growth of need of compensation of symptoms of old age is to be expected. In this context, also the decrease of the capability of hearing of aging people becomes a more and more important issue. For compensation of this deficiency, digitally programmable hearing aids and finally fully digital hearing aids were developed. The possibility of programming a hearing aid allows to adapt the amplification of the frequency spectrum of acoustical waves in various individual hearing situations, which request specially adjusted amplifying behavior of the hearing aid.

Adjusting a hearing aid to the individual hearing loss and the individual requests of the patient are relieved very much by the modern programmable hearing aids, which allow to program an automatic or manual volume adjustment, the automatic or manual election of hearing programs, the implementation of interfering background noise and extinguishing noise or speech recognition. A hearing aid can also be programmed to memorize specific hearing situations individually occurring for a person staying in a certain environment with a characteristic noise spectrum and to adjust the hearing aid to these specific environment. In particular, the hearing aid can be programmed to damp pulsed noise. Further, some programs are configured to suppress wind noise. Furthermore, a program for controlling an adaptive multi-channel-direction microphone can be implemented, which automatically switches between omni-directional mode and directional mode and set in this way the ideal direction effect. Additionally, a feedback blocking program can be provided, which prevents feedback effects by recognizing the feedback part of the audio spectrum.

For a conventional programming of a hearing aid, various methods are provided.

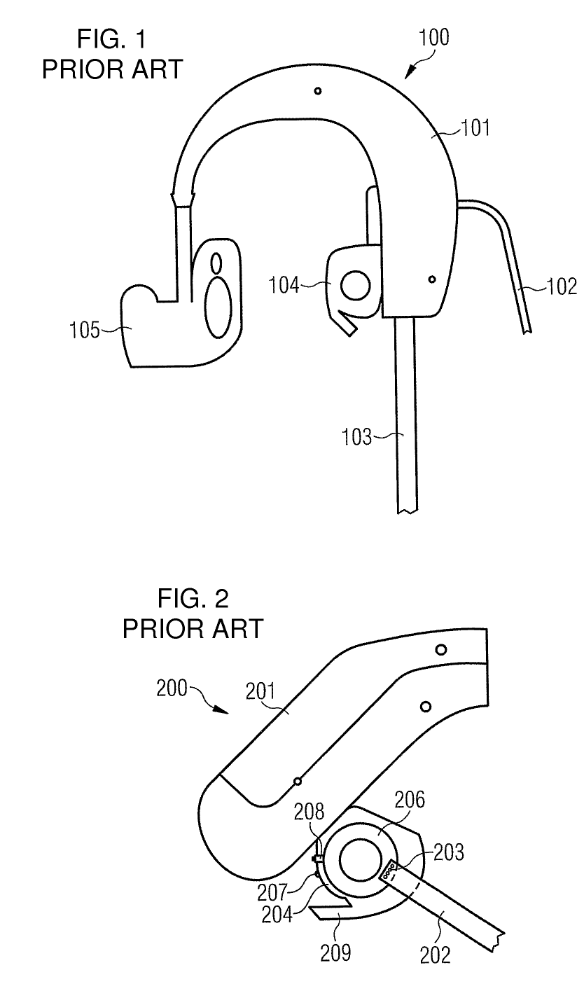

FIG. 1 illustrates a conventional behind-the-ear (BTE) hearing aid 100 having a housing 101 accommodating the common electronic circuits of the hearing aid 100. Furthermore, the hearing aid 100 includes an otoplasty 105 fitted to the individual ear shape of the user. Additionally, a data cable 102 transferring data to the hearing aid 100 is connected to a CS44 interface (not shown in FIG. 1) of the hearing aid 100, wherein the CS44 interface includes a CS44 socket (not shown in FIG. 1). Further, a power supply cable 103 is connected to the hearing aid 100, which is configured to supply electrical energy to the hearing aid 100. Furthermore, the hearing aid 100 includes a battery compartment 104 configured to receive a battery, which is provided to supply electrical energy to the hearing aid 100. However, the CS44 programming socket usually needs substantial internal space of the hearing aid 100, which results in an increase of the size of the hearing aid 100. Alternatively, in case the dimension of the hearing aid 100 is given, internal space for electronic circuits and microphones in the hearing aid 100 is reduced. Further, at least two separate cables are needed for programming and supplying energy to the hearing aid.

Alternatively, in some other conventional hearing aids without a CS44 socket programmable battery pills are provided to be inserted into the battery compartment of the hearing aid as it is shown in FIG. 2. FIG. 2 illustrates an alternative technology for programming a hearing aid 200 including a housing 201, wherein a flexible cable 202 is connected to contact pins 203 arranged on the programmable battery pill 206 in a battery compartment 204 for transferring programming data to the programmable battery pill 206. Before connecting the flexible cable 202 to the battery pill 206, the battery compartment 204 usually is opened by pulling a hold 209. Further, a protrusion 207 is disposed on the battery compartment, which engages with a corresponding recess in the battery compartment receiving chamber in the hearing aid 200, when the battery compartment is pivoted back into the battery compartment receiving chamber of the hearing aid 200, after having completed the data transfer to the hearing aid 200. There are also some contact pins 208 on the battery pill 206, which are configured to connect to corresponding contact pins located on the inner wall of the battery compartment receiving chamber, when the battery compartment 204 is closed. These corresponding contact pins may be for example connected to an integrated circuit for example on a printed circuit board (PCB) arranged within the housing 201 of the hearing aid 200. However, in this technical design, the flexible cable 202 connected to the battery pill 206 is fragile and easy to break.

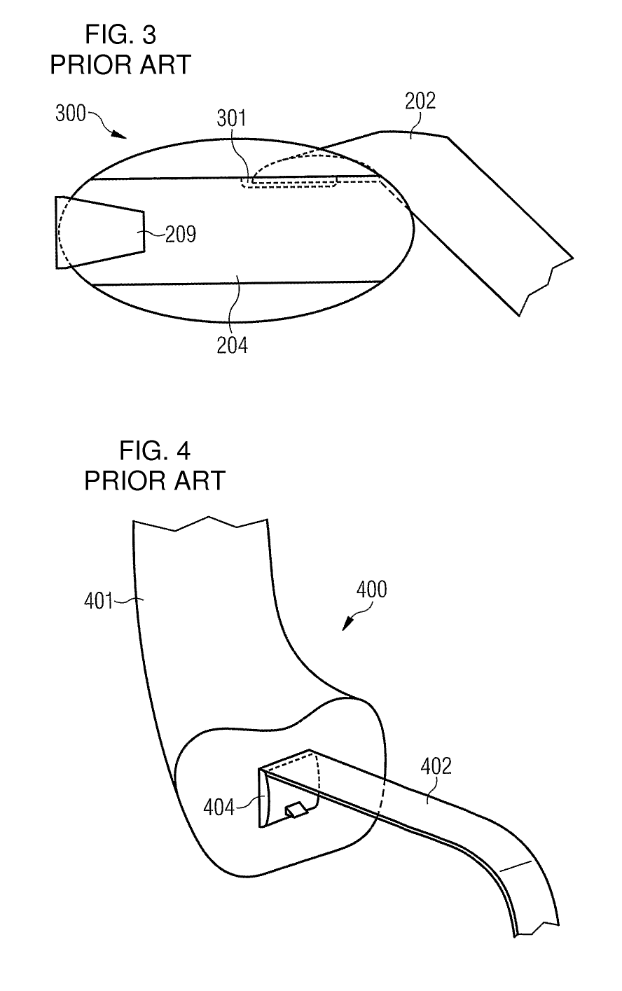

FIG. 3 illustrates a side view 300 of the hearing aid 200, when the battery compartment 204 is closed, such that the flexible programming cable 202 is directly inserted into the hearing aid 200 through a slot opening 301. As shown in FIG. 3, an additional slot opening 301 is required for the flexible cable to be guided out of the hearing aid 200. The slot opening 301 would allow moisture to enter the hearing aid 200 via this slot opening 301 on the battery compartment 204.

FIG. 4 shows a similar arrangement for programming a hearing aid, wherein an in-the-ear (ITE) hearing aid 400, which has a housing 401, is shown. The ITE hearing aid 400 is connected to a programming cable 402 by connecting the programming cable with the outside of the battery compartment 404. When the battery compartment 404 is closed, the programming cable 402 runs out of the ITE hearing aid 400 through a slot opening provided on the housing 401 of the battery compartment 404. As discussed above, also in this case the slot opening for the programming cable 402 would allow moisture to enter the hearing aid 400 via said slot opening between the battery compartment 404 and the housing 401.

In another conventional hearing aid, wireless programming is used, wherein a remote control unit is used to program the hearing aid wirelessly via using a wireless radio link to the hearing aid to be programmed and a computer with a hearing aid program controls the remote control unit for example by means of a USB connection between the computer and the remote control unit. However, the wireless programming is only available for a limited number of specific hearing aid models and most hearing models do not support wireless programming. Furthermore, the data rate of transfer over wireless transmission is slow and thus the programming time is rather long.

In another conventional hearing aid, a so-called Cora T Box is used for programming the hearing aid, wherein in addition to a power cable also a CS44 cable for programming is connected to the Cora T-Box, which is connected to the hearing aid by a power cable. But the employment of the Cora T-Box is extremely slow to program the hearing aid and it is not feasible to deploy the Cora T-Box to customers, since a major investment would be necessary for purchasing a specific product.

Various embodiments provide an electrical hearing aid adapter, which may include a first end portion and a second end portion, the first end portion including a first electrical contact portion, and the second end portion including an interface configured to transfer data to the first electrical contact portion. The first end portion may be formed in such a manner that it corresponds to the shape of a battery compartment receiving chamber being configured to receive a hearing aid battery compartment. The battery compartment receiving chamber may include a second electrical contact portion on the inner surface thereof. The first electrical contact portion may be arranged such that it electrically contacts to the second electrical contact portion when the first end portion is inserted into the battery compartment receiving chamber.

In various embodiments, an electrical hearing aid adapter is provided, which couples a programming cable for example being connected e.g. to a computer and having a specific interface and the hearing aid, which does not include this specific interface itself.

In various embodiments, the specific shape of the first end portion of the electrical hearing aid adapter, which is formed in such a manner that it corresponds to the shape of a battery compartment receiving chamber of the hearing aid, provides a plurality of advantages such as e.g. an easy and cost-efficient way of programming a hearing aid which is not provided with a specific programming interface without the need of changing the design of the hearing aid (e.g. without having to provide a slot opening for the cable to be guided out of the housing of the hearing aid. Thus, the first end portion of the electrical hearing aid adapter can be inserted into the opened battery compartment receiving chamber of the hearing aid and an electrical contact may be established for example between a computer which provides the programming code and the hearing aid to be programmed.

According to an embodiment, the electrical hearing aid adapter may be configured such that the first end portion is formed in such a manner that it corresponds to the shape of a battery compartment receiving chamber of a behind-the-ear (BTE) hearing aid.

A BTE hearing aid may include a hearing aid, a customary made otoplasty and a sound tube. In various embodiments, the BTE hearing aid device is capable of compensating hearing deficiencies in the most various manner. Since the BTE hearing aid device may have much space inside the housing for electronics in accordance with an embodiment, this BTE hearing aid device can realize various technical options as well as high amplifying power. In case of serious hearing deficiencies a higher amplification is made possible due to the large distance between the microphone of the BTE hearing aid an the position, where the sound comes out of the sound tube, which can be arranged next to the eardrum, since the acoustical feedback can be reduced thereby. Furthermore, in an embodiment, the BTE hearing aid device makes it possible to let open the ear cannel by providing the otoplasty with a ventilation hole, which allows a pressure equalization between the inner ear and the environment.

According to an alternative embodiment, the electrical hearing aid adapter may be configured such that the first end portion is formed in such a manner that it corresponds to the shape of a battery compartment receiving chamber of an in-the-ear hearing aid.

The in-the-ear (ITE) hearing aid has a housing, which fills the auricle substantially completely. ITE hearing aids can use the anatomical advantages of the external ear.

Further, the first end portion of the electrical hearing aid adapter can be formed in a curved shape such that the curved shape of the first end portion matches with the curved interior shape of a battery compartment receiving chamber of a hearing aid.

In this way, the first end portion of the electrical hearing aid adapter may fill the entire battery compartment receiving chamber of the hearing aid such that a definite connection between the electrical hearing aid adapter and the hearing aid can be realized. Thus, the electrical terminals in the battery compartment receiving chamber like the contact pins for programming the hearing aid or the battery contact of the hearing aid (which are exposed in the interior of the battery compartment receiving chamber) can be easily contacted by the contact elements, which are placed on the first end portion of the electrical hearing aid adapter.

In another embodiment, the electrical hearing aid adapter may be configured such that the first electrical contact portion includes at least two first contact pins.

According to an embodiment, one of the at least two first contact pins is a clock pin (configured to receive a clock signal) and at least one of the at least two first contact pins is a data pin (configured to receive a data signal).

In that way, a synchronized data transmission can be realized, wherein the transmission of data between transmitter and receiver is chronologically synchronized by a clock signal.

The contact portion can also be arranged in the center of the curved first end portion at the extreme end of the first end portion.

In an alternative embodiment, the electrical hearing aid adapter may include a protrusion formed on one side of the first end portion in such a manner that it receives, in case the first end portion is inserted into the battery compartment receiving chamber of a hearing aid, a retaining portion of the hearing aid, which retains the battery compartment, if the battery compartment receiving chamber is closed.

Coupling the protrusion of the electrical hearing aid adapter to the retaining portion of the hearing aid may ensure a sufficiently definite connection between the electrical hearing aid adapter and the hearing aid, when the programming process is carried out.

According to another embodiment, the interface of the electrical hearing aid adapter configured to transfer data to the first electrical contact portion is a wired interface.

Providing a wired interface allows to implement an interference-free data transmission with high data transmission rate.

The interface for transferring data to the first electrical contact portion may also be a wireless interface.

Using a wireless interface makes the programming of the hearing aid very flexible. By way of example, the hearing aid can be programmed, while the hearing aid is worn by the user.

The interface configured to transfer data to the first electrical contact portion may be a CS-44 interface. In other words, the interface may be configured in accordance with the CS-44 standard.

Further, the electrical hearing aid adapter may include an electrical battery contact for contacting the battery in the hearing aid battery compartment.

Integrating the battery contact into the hearing aid adapter has the advantage that the current supply and the transmission of data can be realized by a single device.

The electrical battery contact may extend to the first end portion of the electrical hearing aid adapter.

Arranging the battery contact on the first end portion makes it possible to couple the battery contact with the electrical supply contact in the battery compartment receiving chamber at the same time, when the first electrical contact of the electrical hearing aid adapter is coupled to the second electrical contact of the hearing aid such that the hearing aid can be programmed and supplied with energy the same time by a single device.

According to an embodiment, the electrical battery contact of the electrical hearing aid adapter is arranged on a side portion of the electrical hearing aid adapter, which is oriented substantially perpendicular to the surface of the first electrical contact portion.

According to another embodiment, the electrical hearing aid adapter may further include a coverage, which is disposed on the side portion, where the battery contact is arranged, wherein the coverage covers at least a part of the battery contact. Hence, a protection of the sensitive battery contact is realized.

According to an embodiment, the coverage of the electrical hearing aid adapter may include or may be made from plastic. Using plastic for the coverage allows to insulate the battery contact against the environment.

The electrical hearing aid adapter may also include a base disposed on the side portion opposed to the side portion, where the battery contact is integrated.

For example, the electrical hearing aid adapter may include a space between the base and the first end portion such that the side wall of the battery compartment receiving chamber of a hearing aid is inserted into the space, in case the first end portion is inserted into the battery compartment receiving chamber.

According to an embodiment, the base of the electrical hearing aid adapter may include or may be made from plastic. Using plastic as the material for the base of the electrical hearing aid adapter makes the adapter lightweight and cost-efficient.

According to an alternative embodiment, the first electrical contact portion of the electrical hearing aid adapter is formed in such a manner that it is securely connectable to the hearing aid by inserting the first end portion of the electrical hearing aid adapter into the battery compartment receiving chamber of the hearing aid, in case the battery compartment of the hearing aid is opened.

According to another embodiment, a wireless communication arrangement may include an electrical hearing aid adapter and a remote controller, wherein the wireless interface is wirelessly linked to the remote controller. Using the wireless communication arrangement allows a very flexible data transmission also during the use of the hearing aid.

The remote controller of the wireless communication arrangement may be configured to wirelessly program the hearing aid by wirelessly transferring the programming data to the interface configured to transfer data to the first electrical contact portion of the electrical hearing aid adapter.

According to an embodiment, a method for transferring data to a hearing aid using the above-mentioned electrical hearing aid adapter is provided, wherein data are received by the interface on the second end portion of the electrical hearing aid adapter. Then, the received data are transferred to the first electrical contact portion. Furthermore, data are transferred from the first electrical contact portion to the second electrical contact portion on the inner surface of the battery compartment receiving chamber of the hearing aid.

Furthermore, a method for transferring data to a hearing aid is provided, wherein the transferred data are one of the following data: parameters, control code, software, production test information, special features or programs.

Furthermore, a method for electrically charging a hearing aid using the above-mentioned electrical hearing aid adapter is provided, wherein electrical charge is transferred to the interface on the second end portion of the electrical hearing aid adapter. Then, the received electrical charge is transferred to the first electrical contact portion. Furthermore, the electrical charge is transferred from the first electrical contact portion to the second electrical contact portion on the inner surface of the battery compartment receiving chamber of the hearing aid.

Using the first electrical contact portion also for transferring charge makes it possible to further simplify the electrical hearing aid adapter by omitting the electrical battery contact of the electrical hearing aid adapter.

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows an arrangement for programming a hearing aid using a CS44 interface;

FIG. 2 shows an arrangement for programming a hearing aid using a programmable battery pill;

FIG. 3 shows the hearing aid of FIG. 2, wherein the battery compartment of the hearing aid is closed;

FIG. 4 shows an arrangement for programming an in-the-ear hearing aid;

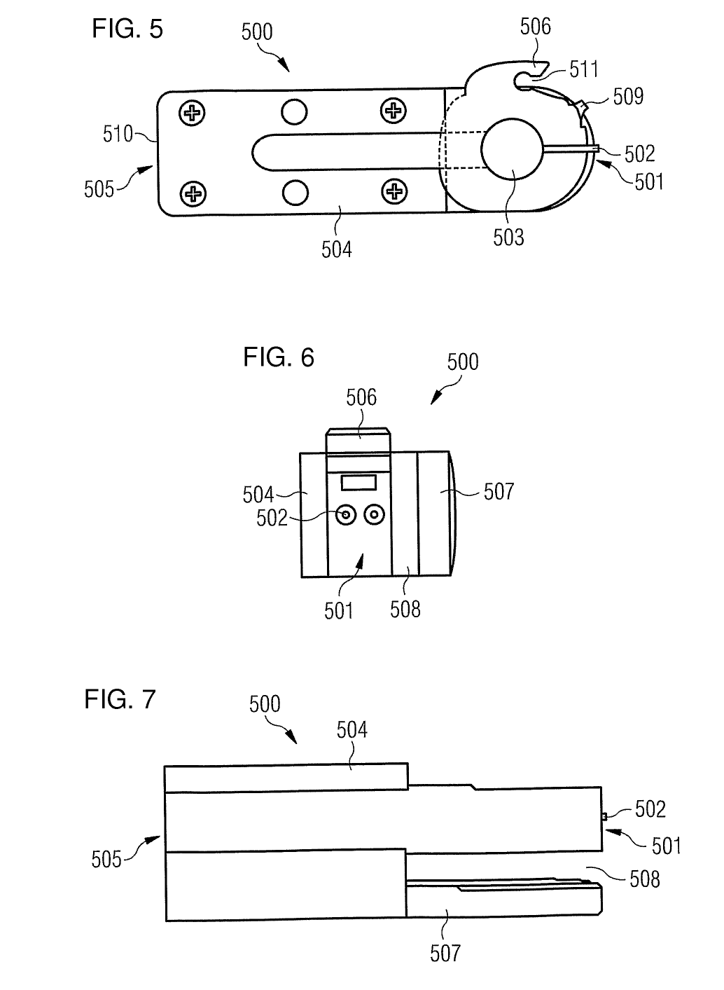

FIG. 5 shows a front view of an electrical hearing aid adapter according to an embodiment;

FIG. 6 is a side view of the electrical hearing aid adapter illustrated in FIG. 5;

FIG. 7 is a top view of the electrical hearing aid adapter shown in FIG. 5 and FIG. 6;

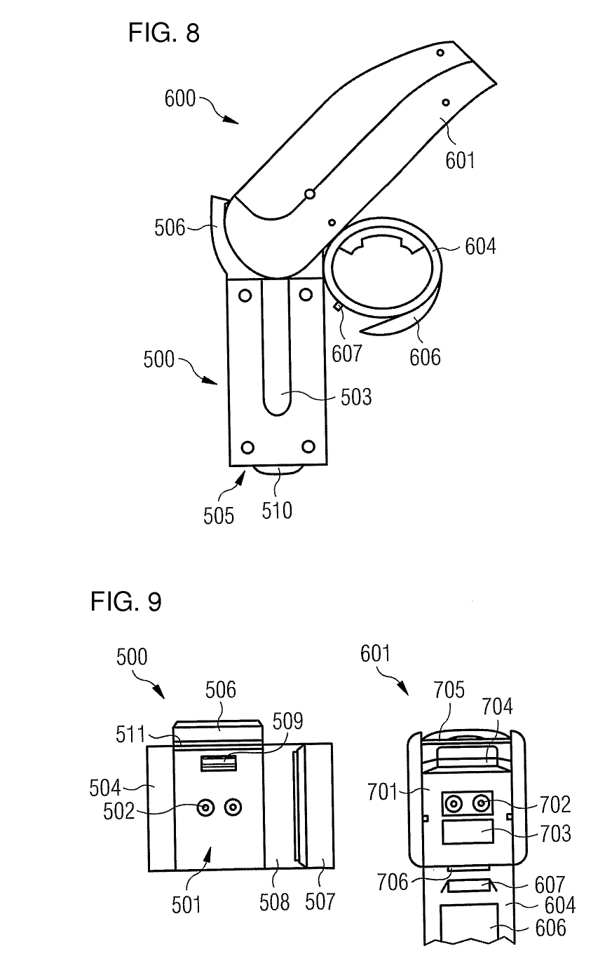

FIG. 8 is a front view showing an arrangement according to an embodiment;

FIG. 9 is a side view illustrating the electrical hearing aid adapter according to an embodiment and a corresponding hearing aid;

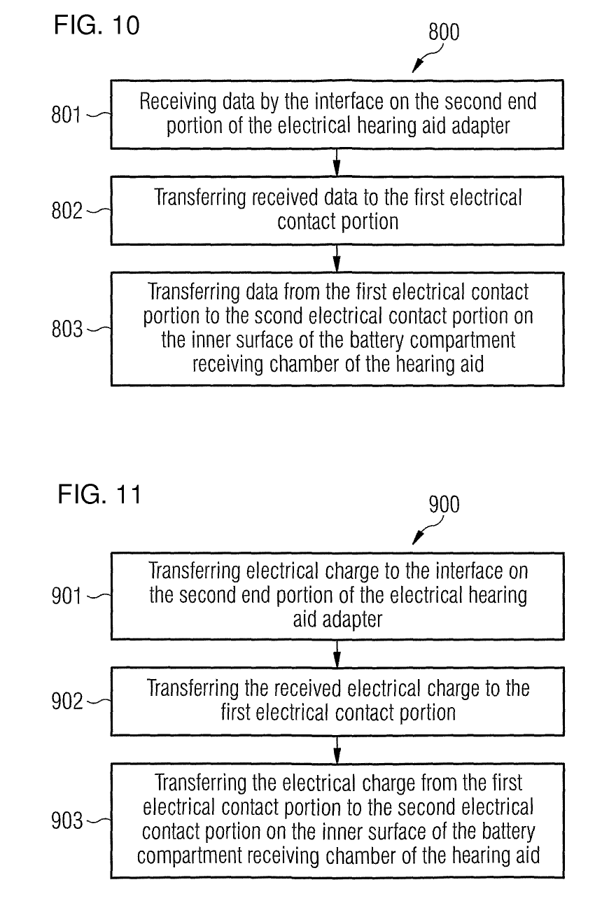

FIG. 10 illustrates a method for transferring data to a hearing aid according to an embodiment; and

FIG. 11 illustrates a method for transferring data to a hearing aid according to another embodiment.

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

FIG. 5 illustrates an electrical hearing aid adapter 500, which is configured to transfer programming data to a hearing aid, according to an embodiment.

The electrical hearing aid adapter 500 may include an end portion 501, which is formed in such a manner that the first end portion 501 matches to the shape of a battery compartment receiving chamber (not shown in FIG. 5) being configured to receive a hearing aid battery compartment. For example, the first end portion 501 in FIG. 5 may have a curved shape, which corresponds to the curved inner shape of a battery compartment receiving chamber of a hearing aid. Additionally, a protrusion 509 may be provided on the first end portion 501. By way of example, the protrusion 509 may be inserted into a recess on the inner wall of the battery compartment receiving chamber of a hearing aid to definitely couple the electrical hearing aid adapter to the hearing aid. Furthermore, electrical contacts 502 may be arranged on the first end portion 501, which can be used for transferring data, provide a clock signal, or even electrical current to the hearing aid. For example, the electrical contacts 502 may be configured to transfer digital data. Alternatively, the electrical contacts may be configured to transfer analogue data. In an alternative embodiment, at least one of the electrical contacts 502 is a clock pin and at least one of the electrical contacts is a data pin configured to transfer data to a hearing aid. In an embodiment, the electrical contacts may be configured as programming contact pins, which may correspond to programming contact pins of the hearing aid disposed in the battery compartment receiving chamber of the hearing aid. An electrical contact 503 may be provided on the upper side of the electrical hearing aid adapter 500, which can be used for supplying electrical energy to a hearing aid. For protecting the electrical contact 503, a coverage 504 may be provided on the front side of the electrical hearing aid adapter 500. In an embodiment, the coverage may include or may be made of plastic. Choosing plastic as the coverage material allows to electrically insulate the part of the electrical contact 503, which is not inside the battery compartment receiving chamber, when the electrical hearing aid adapter is coupled to a hearing aid, for example for programming the hearing aid. Thus, unintended touching the electrical contact 504 by the user may reliably be prevented. Moreover, an end portion 505 is shown in FIG. 5, where an interface 510, for example a CS44 interface may be integrated. The interface 510 may be a wired interface. In an alternative embodiment, the interface is a wireless interface. The interface 510 may be a digital interface configured to transfer digital data. Alternatively, the interface 510 may be an analogue interface configured to transfer analogue data. In addition, FIG. 5 shows a protrusion 506 on the first end portion, which protrudes from the top side of the electrical hearing aid adapter. The protrusion 506 is formed with a recess 511 such that it receives, in case the first end portion 501 is inserted into the battery compartment receiving chamber of a hearing aid, a retaining portion of the hearing aid, which retains the battery compartment, if the battery compartment receiving chamber is closed.

In an alternative embodiment, the electrical hearing aid adapter 500 may include an analogue interface on the second end portion 505. The electrical hearing aid adapter 500 may include an A/D converter configured to convert the analogue data received from the analogue interface. Additionally, the electrical hearing aid adapter 500 may include a first electrical contact portion 502, which is configured to transfer digital data to the electrical contact portion of a hearing aid.

In another embodiment, the electrical hearing aid adapter may include an analogue interface on the second end portion 505 and a first electrical contact portion 502, which is configured to transfer analogue data to the second electrical contact portion of the hearing aid. By way of example, an A/D-converter is integrated into the hearing aid itself or the hearing aid may be an analogue hearing aid.

In still another embodiment, the electrical hearing aid adapter is a pure digital device including a digital interface on the second end portion and a digital electrical contact portion on the first end portion configured such that digital programming data, for example received from a computer, are transferred to the first electrical contact portion 501 and hereinafter transferred to the electrical contact portion of the hearing aid.

The data transferred to a hearing aid by the electrical hearing aid adapter can be parameters like volume parameters or damping parameters.

The data transferred to a hearing aid by the electrical hearing aid adapter may be control code for example for electing specific hearing programs configured for specific hearing situations or control code received from a wireless remote controller.

The data transferred to a hearing aid by the electrical hearing aid adapter may be software, which can be for example specific data used by programs for specific hearing situations.

The data transferred to a hearing aid by the electrical hearing aid adapter may be implemented as or include computer programs. These computer programs may be, for example, programs for decreasing interfering background noise or programs for extinguishing noise. Further, the computer program transferred to the hearing aid may be a computer program configured for speech recognition. The hearing aid may also be configured to receive a computer program, which is configured to memorize specific hearing situations individually occurring for a person staying in certain environments with characteristic noise spectrum and to adjust the hearing aid to these specific conditions. The hearing aid may also receive computer programs being configured to damp pulsed noise. Furthermore, some computer programs transferred to the hearing aid by the electrical hearing aid adapter may be configured to suppress wind noise. Furthermore, a computer program for controlling an adaptive multichannel-direction microphone, which automatically switches between omni-directional and directional mode and set in this way the ideal direction effect, may be transferred to the hearing aid. Additionally, the computer program transferred to the hearing aid may be a feedback blocking, which may prevent feedback effects by recognizing the feedback part of the frequency spectrum.

Furthermore, production test information may be transferred to the hearing aid.

As can be seen in FIG. 6, a base 507 may be arranged on the bottom side of the back side of the electrical hearing aid adapter 500. The base 507 may include or may be made for example from plastic. A space 508 may be provided between the base 507 and the first end portion 501. The space 508 may facilitate the insertion of the first end portion 501 into a battery compartment receiving chamber, since the side wall of the battery compartment receiving chamber of a hearing aid, i.e. a part of the housing of the hearing aid, can be inserted into the space 508.

FIG. 7 is a top view illustrating the electrical hearing aid adapter shown in FIG. 5 and FIG. 6. As shown in FIG. 7, a base 507 may be arranged on the main body with the first end portion 501 and the first electrical contact portion 502 at one side and the plastic coverage 504 is arranged on the main body of the electrical hearing aid adapter at the other side. The lateral dimension of the main body of the electrical hearing aid adapter 500 may correspond to the lateral dimension of a battery compartment receiving chamber of a hearing aid.

FIG. 8 illustrates an arrangement 600 according to an embodiment, wherein the electrical hearing aid adapter 500 is coupled to a hearing aid 601. In the illustrated embodiment, for coupling the electrical hearing aid adapter 500 to the hearing aid 601, the battery compartment 604 of the hearing aid 601 may be flapped out of the battery compartment receiving chamber (not shown in FIG. 8) of the hearing aid 601 and the first end portion of the electrical hearing aid adapter 500 may be inserted into the battery compartment receiving chamber of the hearing aid 601. On the battery compartment 604, a hold 606 may be attached, which is configured for catching the hold 606 in case the battery compartment 604 is closed such that opening of the battery compartment 604 is facilitated by the hold 606. A protrusion 607 may be arranged on the battery compartment 604 for retaining the battery compartment 604 definitely in the battery compartment receiving chamber in case the battery compartment 604 is in closed state. Furthermore, the electrical hearing aid adapter 500 may include a protrusion 506. As can be seen from FIG. 8, the protrusion 506 is at least partly arranged outside the hearing aid 600 such that the hearing aid may be prevented from sliding sidely and leaving the coupling position on the first end portion of the electrical hearing aid adapter 500. Furthermore, an interface 510 may be provided on the second end portion 505 of the electrical hearing aid adapter 500, which can be used for transferring data from a computer to the electrical hearing aid adapter 500. These data are thereinafter transferred by the electrical hearing aid adapter 500 to the hearing aid 601, which consequently does not need the expensive programming interfaces. By way of example, a CS44 interface may be integrated into the electrical hearing aid adapter 500 as the interface 510. Hence, the need of providing each hearing aid with a CS44 interface is avoided.

FIG. 9 illustrates the coupling portions of the electrical hearing aid adapter 500 and the hearing aid 601 in more detail. As indicated, there are contact pins 502 on the first end portion 501 of the electrical hearing aid adapter 500 as well as corresponding contact pins 702 on the inner wall of the battery compartment receiving chamber 701 of the hearing aid 601. These contact pins 502, 702 may correspond to each other such that they can be connected to each other for electrically coupling the electrical hearing aid adapter 500 and the hearing aid 601 such that the hearing aid 601 can be programmed by transferring programming data through the electrical hearing aid adapter 500 and the contact pins 502 and the contact pins 702 to the hearing aid 601.

For mechanical coupling, there are also some fixing elements 506, 509, provided on the first end portion 501 of the electrical aid adapter 500. A corresponding recess 704 may be provided on the inner wall of the battery compartment receiving chamber 701, which recess 704 corresponds to the protrusion 509 on the first end portion 501 of the electrical hearing aid adapter 500. The wall element 705 of the battery compartment receiving chamber of the hearing aid 601 may be inserted into the recess 511, which is arranged next to the protrusion 506 of the electrical hearing aid adapter 500. The opened battery compartment 604 including the hold 606 and the protrusion 607 is also shown as a part of the hearing aid 601. In the closed state, i.e. in case the battery compartment 604 is inserted into the battery compartment receiving chamber 701, the protrusion 607 engages with the recess 704 such that the battery compartment 604 is definitely coupled with the battery compartment receiving chamber 701.

A recess portion 703 may be disposed on the inner wall of the battery compartment receiving chamber 701, which recess portion 703 is configured such that it is able to receive the protrusion 706 of the battery compartment 604.

FIG. 10 illustrates a method 800 for transferring data to a hearing aid using the described electrical hearing aid adapter. In 801, data are received by the interface on the second end portion of the electrical hearing aid adapter. In 802, the received data are transferred to the first electrical contact portion. In 803, the data are transferred from the first electrical contact portion to the second electrical contact portion on the inner surface of the battery compartment receiving chamber of the hearing aid.

FIG. 11 illustrates an alternative method 900 for transferring data to a hearing aid using the electrical hearing aid adapter mentioned-above. In 901, electrical charge is transferred to the interface on the second end portion of the electrical hearing aid adapter. In 902, the received electrical charge is transferred to the first electrical contact portion. In 903, the electrical charge is transferred from the first electrical contact portion to the second electrical contact portion on the inner surface of the battery compartment receiving chamber of the hearing aid.

Using the first electrical contact portion also for transferring charge makes it possible to further simplify the electrical hearing aid adapter by omitting the electrical battery contact of the electrical hearing aid adapter.

Hence, an easy plug and program concept is provided, which can be easily performed by any user without special training. It is also very useful in mass production, for use in audiology clinics and in hearing aid dispenser sites for dispensing the hearing aid over the counter, where the use may select the configuration and program the hearing aid easily and fast. The adapter in accordance with various embodiments could be mounted vertically on a horizontal platform, for example a desk or a table, while the user can just hooke the hearing aid over for programming.

Consequently, the slot opening required in the battery compartment of a conventional hearing aid as shown in FIG. 3 and FIG. 4, is removed. Hence, by removing this slot opening on the battery compartment, the hearing aid is better protected from moisture, since moisture, for example water, is harder to get into the hearing aid via the battery compartment without a slot opening as it is provided by the above-mentioned embodiments of the invention. Furthermore, a fast programming rate is retained compared to a conventional wireless programming when programming the hearing aid via the physical contact pins, which may save programming time and may induce a higher throughput of programming data.

Further, the plug and program adapter as described above is much more robust than the conventional arrangements, using a flexible cable for transferring programming data to the hearing aid, since the flexible cable is fragile and easily broken.

Since the electrical hearing aid adapter allows to omit the CS44 interface on the hearing aid, the production of the hearing aids can be made much simpler and more cost effective.

Due to the simple design of the electrical hearing adapter, the adapter is handy and easy to use.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-24. (canceled)

25. An electrical hearing aid adapter, comprising:
a first end portion having a first electrical contact portion;
a second end portion having an interface configured to transfer data to said first electrical contact portion;
said first end portion formed in such a manner that said first end portion corresponds to a shape of a battery compartment receiving chamber configured to receive a hearing aid battery compartment, the battery compartment receiving chamber having a second electrical contact portion on an inner surface thereof; and
said first electrical contact portion disposed such that said first electrical contact portion electrically contacts to the second electrical contact portion when said first end portion is inserted into the battery compartment receiving chamber.

26. The electrical hearing aid adapter according to claim 25, wherein said first end portion is formed in such a manner that said first end portion corresponds to the shape of the battery compartment receiving chamber of a behind-the-ear hearing aid.

27. The electrical hearing aid adapter according to claim 25, wherein said first end portion is formed in such a manner that said first end portion corresponds to the shape of the battery compartment receiving chamber of an in-the-ear hearing aid.

28. The electrical hearing aid adapter according to claim 25, wherein said first end portion is formed in a curved shape such that said curved shape of said first end portion matches with a curved interior shape of the battery compartment receiving chamber of a hearing aid.

29. The electrical hearing aid adapter according to claim 25, wherein said first electrical contact portion has at least two first contact pins.

30. The electrical hearing aid adapter according to claim 29, wherein said at least two first contact pins include a clock pin and a data pin.

31. The electrical hearing aid adapter according to claim 28, wherein said first electrical contact portion is disposed in a center of said first end portion having said curved shape and at an extreme end of said first end portion.

32. The electrical hearing aid adapter according to claim 25, further comprising a protrusion formed on one side of said first end portion in such a manner that said protrusion receives, in case said first end portion is inserted into the battery compartment receiving chamber of a hearing aid, a retaining portion of the hearing aid, which retains the battery compartment, if the battery compartment receiving chamber is closed.

33. The electrical hearing aid adapter according to claim 25, wherein said interface is configured to transfer the data to said first electrical contact portion and is a wired interface.

34. The electrical hearing aid adapter according to claim 25, wherein said interface transfers the data to said first electrical contact portion and is a wireless interface.

35. The electrical hearing aid adapter according to claim 33, wherein said interface is configured to transfer data to said first electrical contact portion and is a CS-44 interface.

36. The electrical hearing aid adapter according to claim 25, further comprising an electrical battery contact for contacting a battery in the hearing aid battery compartment.

37. The electrical hearing aid adapter according to claim 36, wherein said electrical battery contact extends to said first end portion.

38. The electrical hearing aid adapter according to claim 36, wherein said electrical battery contact is disposed on a side portion of the electrical hearing aid adapter, which is oriented substantially perpendicular to a surface of said first electrical contact portion.

39. The electrical hearing aid adapter according to claim 36, further comprising a coverage, which is disposed on a side portion, where said electrical battery contact is disposed, said coverage covering at least a part of said electrical battery contact.

40. The electrical hearing aid adapter according to claim 39, wherein said coverage is formed from plastic.

41. The electrical hearing aid adapter according to claim 25, further comprising a base disposed on a further side portion opposite to said side portion, where said electrical battery contact is integrated.

42. The electrical hearing aid adapter according to claim 41, wherein said base and said first end portion define a space there-between such that a side wall of the battery compartment receiving chamber of a hearing aid is inserted into said space, in case said first end portion is inserted into the battery compartment receiving chamber.

43. The electrical hearing aid adapter according to claim 41, wherein said base is formed from plastic.

44. The electrical hearing aid adapter according to claim 25, wherein said first electrical contact portion is formed in such a manner that said first electrical contact portion is securely connectable to a hearing aid by inserting said first end portion of the electrical hearing aid adapter into the battery compartment receiving chamber of the hearing aid, in case the battery compartment of the hearing aid is opened.

45. A communication configuration, comprising:
an electrical hearing aid adapter, containing:
a first end portion having a first electrical contact portion;
a second end portion having an interface configured to transfer data to said first electrical contact portion;
said first end portion formed in such a manner that said first end portion corresponds to a shape of a battery compartment receiving chamber configured to receive a hearing aid battery compartment, the battery compartment receiving chamber having a second electrical contact portion on an inner surface thereof; and
said first electrical contact portion disposed such that said first electrical contact portion electrically contacts to the second electrical contact portion when said first end portion is inserted into the battery compartment receiving chamber; and
a remote controller linked to said interface.

46. The communication configuration according to claim 45, wherein said remote controller is configured to program a hearing aid by transferring programming data to said interface configured to transfer the data to said first electrical contact portion of said electrical hearing aid adapter.

47. A method for transferring data to a hearing aid using an electrical hearing aid adapter containing a first end portion having a first electrical contact portion and a second end portion having an interface configured to transfer data to the first electrical contact portion, the first end portion formed in such a manner that the first end portion corresponds to a shape of a battery compartment receiving chamber configured to receive a hearing aid battery compartment, the battery compartment receiving chamber having a second electrical contact portion on an inner surface thereof and the first electrical contact portion disposed such that the first electrical contact portion electrically contacts to the second electrical contact portion when the first end portion is inserted into the battery compartment receiving chamber, the method comprising the steps of:
receiving the data by means of the interface on the second end portion of the electrical hearing aid adapter;
transferring the data received to the first electrical contact portion; and
transferring the data from the first electrical contact portion to the second electrical contact portion on the inner surface of the battery compartment receiving chamber of the hearing aid.

48. A method for electrically charging a hearing aid using an electrical hearing aid adapter containing a first end portion having a first electrical contact portion and a second end portion having an interface configured to transfer data to the first electrical contact portion, the first end portion formed in such a manner that the first end portion corresponds to a shape of a battery compartment receiving chamber configured to receive a hearing aid battery compartment, the battery compartment receiving chamber having a second electrical contact portion on an inner surface thereof and the first electrical contact portion disposed such that the first electrical contact portion electrically contacts to the second electrical contact portion when the first end portion is inserted into the battery compartment receiving chamber, the method comprising the steps of:
transferring electrical charge to the interface on the second end portion of the electrical hearing aid adapter;
transferring the electrical charge received to the first electrical contact portion; and
transferring the electrical charge from the first electrical contact portion to the second electrical contact portion on the inner surface of the battery compartment receiving chamber of the hearing aid.
